(19) United States
(12) Patent Application Publication
(10) Pub. No.: US 2007/0244698 A1
(43) Pub. Date: Oct. 18, 2007

(54) RESPONSE-SELECT NULL STEERING CIRCUIT

(76) Inventors: Jeffery D. Dugger, Mountain View, CA (US); Paul D. Smith, Pleasanton, CA (US); Paul E. Hasler, Atlanta, GA (US); Hans W. Klein, Danville, CA (US)

Correspondence Address: WILLIAM L. PARADICE, III, 4880 STEVENS CREEK BOULEVARD, SUITE 201, SAN JOSE, CA, 95129, US

(21) Appl. No.: 11/737,127

(22) Filed: Apr. 18, 2007

Related U.S. Application Data
(60) Provisional application No. 60/793,281, filed on Apr. 18, 2006.

(51) Int. Cl. G10L 21/02

(52) U.S. Cl. 704/228

(57) ABSTRACT

A response select null steering circuit includes a beamformer, a plurality of separate fixed filters, and a selection circuit. In response to sound signals emitted from a desired speaker and an unwanted interferer, a sum signal containing signal components of the speaker and interferer is generated, and the beamformer generates a difference signal that suppresses signal components of the speaker. Each filter provides a null in a unique direction relative to the desired speaker, and can be individually configured to suppress sound signals from an interferer in a particular direction. The selection circuit selects the filter output signal that has the least amount of signal energy as achieving the best suppression of the unwanted interferer.

### CROSS-REFERENCE TO RELATED APPLICATION

This application claims the benefit under 35 USC 119(e) of the co-pending and commonly owned U.S. Provisional Application No. 60/793,281 entitled “Response-Select Null Steering Circuit” filed on Apr. 18, 2006, which is incorporated by reference herein.

### FIELD OF THE INVENTION

The present invention relates generally to audio signal processing and more particularly to the cancellation of unwanted interference signals from an audio reception unit.

### BACKGROUND

Directional microphone systems are designed to sense sound from a particular source such as a desired speaker located in a specified direction while rejecting, filtering out, blocking, or otherwise attenuating sound from other sources such as undesired bystanders or noise located in other directions. To achieve a high degree of directionality, microphones typically include an array of two or microphone sensors or transducers contained in a mechanical enclosure. The enclosure typically includes one or more acoustic ports for receiving sound and additional material for guiding sound from within the beam angle to sensing elements and blocking sound from other directions.

Directional microphones may be beneficially applied to a variety of applications such as conference rooms, home automation, automotive voice commands, personal computers, telephone headsets, personal digital assistants, and the like. These applications typically have one or more desired sources of sound accompanied by one or more noise sources. In such applications, it is desired to increase the signal to noise ratio (SNR) between the desired source and unwanted interferers. Attempts to do so using frequency filtering are largely unsuccessful because the frequencies to be filtered out are typically the same as the desired source, for example, in a telephone headset that seeks to preserve the desired speaker's voice while simultaneously canceling the voices of people other than the speaker such as bystanders. Sound sources other than the desired speaker are referred to herein as interferers.

Because the sound signals from the desired speaker and unwanted interferers are typically emitted from different locations relative to the microphone, the spatial separation between the speaker and interferers can be exploited to separate the desired sound signal from the unwanted interferer sound signal using spatial filters such as a delay-and-sum beamformer or a Griffiths-Jim adaptive beamformer. More specifically, nulls in the directional sensitivity pattern of the microphone array may be used for interference cancellation, while a fixed gain in a known directional location (e.g., corresponding to the desired speaker) may be used to preserve the sound signals emitted by the desired speaker.

For example, FIGS. 1A-1B depict a microphone array 100 having two microphone sensors M1 and M2 positioned along a longitudinal axis 101 and separated by a distance d. A desired speaker (SPKR) is located in the 0 degree (°) direction of the axis 101, and an interferer (INT) is located at an angle θ from the 0° direction of axis 101. Assuming the INT is in the far field, sound waves emitted from INT travel a distance r to M2 and travel a distance r+Δr to M1. Thus, the phase difference in sound signals received at the two sensors M1 and M2, which may be expressed as kΔr=2πΔr/λ (where λ is the wavelength sound waves), may be used to distinguish between sound signals emitted from the SPKR and from the INT.

A fixed null-steering system such as a well-known beamformer filters the microphone signal produced by sensor Ml and subtracts it from the microphone signal produced by sensor M2 to generate an output signal that suppresses sound signals attributed to INT, thereby creating a fixed sensitivity pattern (also known as polar response pattern). However, in many applications, the location and direction of the interferer (INT) may not be known and/or may change even though the location and direction of the desired speaker SPKR remains constant. In such applications, adaptive filters may be employed to continually modify the system response (e.g., by continuously modifying the polar response pattern) so that the sound processing system steers a “null” in the direction of the interferer. To distinguish between the desired speaker SPKR and the unwanted interferer INT, sound processing systems may employ a combination of fixed beamformers and adaptive filters.

For example, FIG. 2 shows a well-known Griffiths-Jim adaptive beamformer circuit 200 that includes a fixed beamformer and an adaptive filter. Filter circuit 200 is shown to include microphone sensors M1-M2, a delay element 210, subtraction circuits 221-222, summing circuit 223, an adaptive filter 230, and a signal power estimator circuit 240. As depicted in FIG. 2, the speaker SPKR is located along the longitudinal axis of the microphone sensors M1-M2 at a reference angle of 0°. Further, an interferer INT (not shown in FIG. 2) is located at some unknown angle θ relative to the SPKR. In response to sound generated by INT and SPKR, sensor M1 produces a first input signal IN1 and sensor M2 produces a second input signal IN2. IN1 is provided to delay element 210, which is typically a low-pass filter (LPF) that produces a delayed input signal IN1D. Signals IN1D and IN2 are summed at summing circuit 223 to generate a sum signal (SUM) containing signal components of both the SPKR and INT, and signal IN1D is subtracted from IN2 by subtraction circuit 221 to generate a difference signal (DIFF) in which signal components of SPKR are suppressed so that DIFF contains mostly signal components of INT. Thus, sensors M1-M2, delay element 210, and subtraction circuit 221 together form a fixed beamformer that suppresses SPKR from DIFF in a well-known manner, for example, by setting the filter coefficients of delay element 210 to suitable values according to the distance between sensors M1-M2 and the direction of SPKR (which is at 0° in FIG. 2).

The difference signal is provided as an input signal to adaptive filter 230, which includes an output to generate a filtered difference output signal FO and includes a control terminal to receive a tuning signal from signal power estimator (SPE) 240. The filtered difference signal FD is subtracted from SUM in subtraction circuit 222 to generate an output signal OUT that dynamically preserves sound components of SPKR while suppressing sound components of INT over a range of changing directions for INT.

As known in the art, SPE circuit 240 estimates the signal power of the output signal OUT, and in response thereto generates a tuning signal (TN) that is used to continuously tune the adaptive filter 230. Although not shown for simplicity, for some applications, the SPE circuit generates the tuning signal TN for the adaptive filter 230 in response to both the output signal OUT and the difference signal (DIFF). Adaptive filter 230, which is typically a finite impulse response (FIR) filter, is continuously tuned in response to TN to suppress the dominant source components in DIFF so that INT sound components are suppressed from its output signal FD. More specifically, the polar response pattern of adaptive filter 230 is continuously modified to continuously steer the null in the direction of INT to minimize the sound energy attributed to INT from the filtered difference signal FD.

It is important to note that adaptive beamformers of type shown in FIG. 2 are implemented using digital circuitry, for example, because FIR filters operate in the digital domain.

Thus, when the filtered difference signal FD is subtracted from the sum signal SUM at subtraction circuit 222, the resultant output signal is a directionally sensitive signal in which the INT components are suppressed and the SPKR components are preserved. For example, if the sum signal SUM is represented as a SPKR component S plus an INT component INT_{SUM} and the filtered difference signal FD represents the estimate of I_{SUM} the output signal OUT=S+INT_{SUM}−FD≈S, and the transfer function of the adaptive filter is H(ω)=INT_{SUM}/FD.

Although effective in providing a directional sensitivity pattern that can dynamically steer a null in the direction of INT, the adaptive filter employed by systems such the Griffiths-Jim circuit 200 requires a complicated algorithm to continuously steer the null in the direction of the interferer INT. In addition, the adaptive filter itself is typically a very complex circuit requiring numerous cascaded filtering stages and various adjustable tap delay lines, which not only consumes a large circuit area but also may be difficult to design and implement.

### BRIEF DESCRIPTION OF THE DRAWINGS

FIGS. 1A-1B depict a microphone system having an array of two sensors deployed in a fixed null-steering environment;

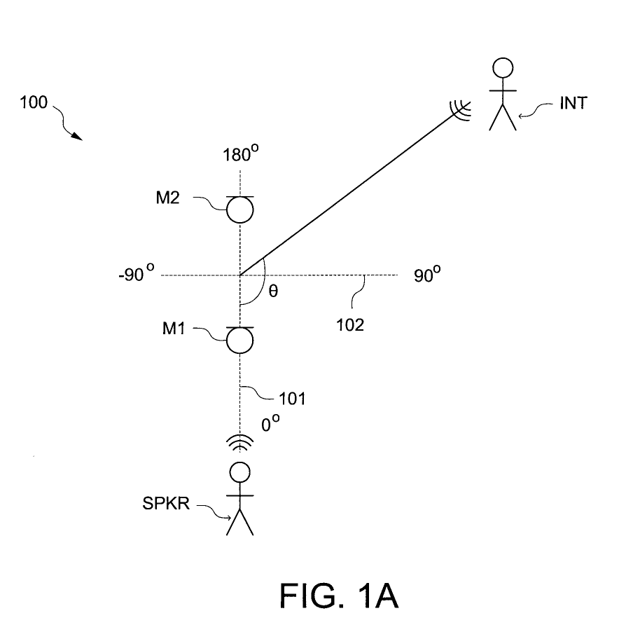

FIG. 2 is block diagram of a two-microphone Griffiths-Jim adaptive beamformer circuit;

FIG. 3 is a sound processing system in accordance with one embodiment of the present invention;

FIG. 4 is a simplified functional block diagram of one embodiment of the compare and select circuit of the sound processing systems of FIG. 3;

FIG. 5 shows illustrative magnitude and phase response plots for three exemplary discrete filters for some embodiments of the sound processing systems of FIG. 3;

FIG. 6A shows an exemplary polar response pattern over a specified frequency range for the first discrete filter of the sound processing systems of FIG. 3;

FIG. 6B shows an exemplary polar response pattern over a specified frequency range for the second discrete filter of the sound processing systems of FIG. 3;

FIG. 6C shows an exemplary polar response pattern over a specified frequency range for the third discrete filter of the sound processing systems of FIG. 3;

FIG. 7A shows an exemplary polar response pattern for a frequency of 200 Hz for the third discrete filter of the sound processing systems of FIG. 3;

FIG. 7B shows an exemplary polar response pattern for a frequency of 1 kHz for the third discrete filter of the sound processing systems of FIG. 3;

FIG. 7C shows an exemplary polar response pattern for a frequency of 4 kHz for the third discrete filter of the sound processing systems of FIG. 3;

FIG. 8A is a block diagram of one embodiment of the selection circuit of the sound processing systems of FIG. 3;

FIG. 8B is a block diagram of another embodiment of the selection circuit of the sound processing systems of FIG. 3;

FIG. 8C is a block diagram of yet another embodiment of the selection circuit of the sound processing systems of FIG. 3; and

FIG. 9 is an illustrative flow chart depicting an exemplary operation for some embodiments of the sound processing systems of FIG. 3.

Like reference numerals refer to corresponding parts throughout the drawing figures.

### DETAILED DESCRIPTION

Embodiments of the present invention are described below in the context of a microphone array having two sensors for simplicity only. It is to be understood that the present embodiments are equally applicable sound processing systems that employ any number of microphone sensors. In the following description, for purposes of explanation, specific nomenclature is set forth to provide a thorough understanding of the present invention. In other instances, well-known circuits and devices are shown in block diagram form to avoid obscuring the present invention unnecessarily. For example, the interconnection between circuit elements or circuit blocks may be shown or described as multi-conductor or single conductor signal lines. Each of the multi-conductor signal lines may alternatively be single-conductor signal lines, and each of the single-conductor signal lines may alternatively be multi-conductor signal lines. Signals and signaling paths shown or described as being single-ended may also be differential, and signals and signaling paths shown or described as being differential may also be single-ended. Further, the logic states of various signals described herein are exemplary and therefore may be reversed or otherwise modified as generally known in the art. Accordingly, the present invention is not to be construed as limited to specific examples described herein but rather includes within its scope all embodiments defined by the appended claims.

In accordance with embodiments of the present invention, a response select null steering circuit includes a beamformer, a summing circuit, a plurality of separate filtering circuits, and a selection circuit. In response to input signals generated by microphone sensors receiving sound signals from a desired speaker and an unwanted interferer, the summing circuit generates a sum signal containing signal components of both the speaker and the interferer. The beamformer generates a difference signal that suppresses signal components of the desired speaker so that the difference signal contains primarily only the signal components of the interferer. Each filtering circuit includes a fixed filter and a subtraction circuit that together provide a different polar response pattern that exhibits a null in a unique direction relative to the desired speaker. In this manner, each filtering circuit may be individually configured to suppress sound signals from an interferer located in a direction associated with the null in the corresponding polar response pattern of the filter. The selection circuit receives the output signals from the various filtering circuits and selects the output signal that has the least amount of signal energy, where the output signal having the least signal energy achieves the best suppression of the unwanted interferer.

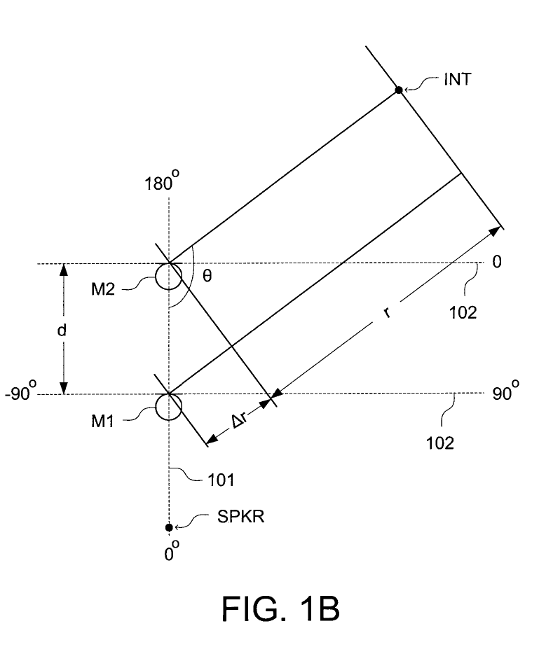

Thus, unlike prior sound processing systems such as the Griffiths-Jim beamformer circuit of FIG. 2, embodiments of the present invention do not require a complex adaptive filter operating according to a complex algorithm that continuously modifies the adaptive filter's polar response pattern to track the changing location of the unwanted interferer. As a result, sound beamformers in accordance with embodiments of the present invention are less complex and much easier to design and implement than prior filter circuits of the Griffiths-Jim type. Further, by employing a plurality of fixed (e.g., non-adaptive) filters that may be individually configured to provide interferer suppression in a corresponding predetermined direction, embodiments of the present invention may provide improved performance over adaptive filters that are responsible for interferer suppression in all directions because such adaptive filters may not always operate as intended. For this reason, performance of audio filtering circuits of the present invention in real-world applications may also be more reliable and more predictable than systems that rely upon adaptive filtering techniques.

Audio filtering circuits of the present invention may be deployed in any suitable system including, for example, conference rooms, home automation, automotive voice commands, personal computers, telecommunications, personal digital assistants, and the like. Applicants have found that null steering circuits in accordance with the present invention are particularly useful in telephone headsets.

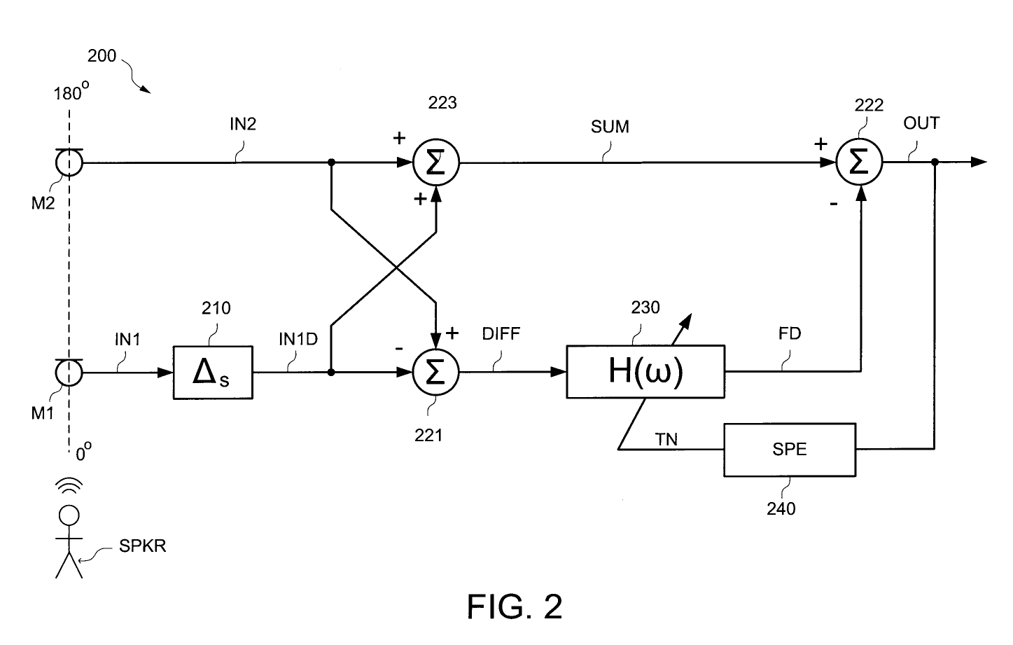

FIG. 3 shows a null-steering response select circuit 300 in accordance with some embodiments of the present invention. Null steering circuit 300 includes microphone sensors M1-M2, a delay element 301A, a gain element 301B, a subtraction circuit 302, a summing circuit 303, a plurality of discrete or individual filtering circuits 310(1)-310(n), and a selection circuit 320. As depicted in FIG. 3, the speaker SPKR is located along the longitudinal axis of the microphone sensors M1-M2 at a reference angle of 0°. Further, an interferer INT (not shown in FIG. 3) is located at some unknown angle θ relative to the SPKR.

In response to sound generated by INT and SPKR, sensor M1 produces a first input signal IN1 and sensor M2 produces a second input signal IN2. IN1 is provided to a delay element 301A that produces a delayed input signal IN1D. For some embodiments, delay element is a second-order low-pass filter (LPF) of the Bessel type that produces a relatively constant delay over a desired frequency range. More specifically, delay element 301A performs an input filtering operation, Δs, on the M1 microphone signal IN1 that preserves the SPKR in a given direction, and well-known gain element 301B provides a near-field gain factor A to signal IN2 to compensate for SPKR being in the near field. The near-field gain factor A allows preservation of a desired source such as the SPKR based on distance as well as direction relative to M1-M2, and provides additional attenuation of the INT in the same direction as the speaker, but at a different distance from the microphone array than the SPKR. This feature can be expanded to multiple microphones and multiple gains. For other embodiments, delay element 301A may employ other types of filters.

For exemplary embodiments described herein, sensors M1-M2 are omni-directional sound transducers in which Ml and M2 may be modeled as follows:

| | | |
|---|---|---|
| M1 | X_{F} = e^{-jωΔ}^{ₘ} | (1) |
| M2 | X_{R} = 1 | (2) |

However, for other embodiments, sensors M1-M2 may be configured to have any suitable directional sensitivity.

Signals IN1D and IN2 are summed at summing circuit 303 to generate a sum signal (SUM) containing signal components of both the SPKR and INT, and signal IN1D is subtracted from IN2 by subtraction circuit 302 to generate a difference signal (DIFF) in which signal components of SPKR are suppressed so that DIFF contains mostly signal components of INT. Thus, sensors M1-M2, delay element 301A, and subtraction circuit 302 together form a fixed beamformer that suppresses SPKR from DIFF according to the polar response pattern implemented by delay element 301A.

Further, for other embodiments, a second delay element (not shown for simplicity) may be provided between gain element 301B and summing circuit 303, where the second delay element provides a filtering function for IN2 that expands the sensitivity pattern to the back half-plane in the direction opposite the SPKR (i.e., along the 180° axis).

The difference signal DIFF is provided as an input signal to each of the plurality of filtering circuits 310(1)-310(n). Each filtering circuit 310 includes a fixed filter 311 and a subtraction circuit 312. Each filter 311 has an input to receive DIFF and has an output coupled to a corresponding subtraction circuit 312, which subtracts the filtered signal FDx provided by the filter 311 from the sum signal SUM to generate a corresponding filter output signal OUTx, where “x” denotes an integer between 1 and n corresponding to one of the filtering circuits 310(1)-310(n). The filter output signals OUT1-OUTn output from corresponding filtering circuits 310(1)-310(n) are provided to selection circuit 320, which selects the filter output signal OUTx that provides the best INT suppression as the selected minimum-energy output signal OUTₘᵢₙ for the null steering circuit 300.

Each of the plurality of filters 311(1)-311(n) is a fixed filter having a different magnitude and phase response so that the filters have polar response patterns with nulls in different directions which may be specified by the corner frequency of the corresponding filter. The filters 311(1)-311(n) may be any type of filter, and each may be configured to have a polar response pattern with a null in a designated direction. In this manner, each of filters 311(1)-311(n) may be optimized to provide INT suppression in a designated direction, which is in contrast to prior art adaptive techniques such as the Griffiths-Jim beamformer circuit that is configured to continuously steer the null in the direction of a dominant interferer.

Thus, in accordance with some embodiments of the present invention, each of the filters 311(1)-311(n) is a separate filter that corresponds to a null in a particular direction. Moreover, any number of null angles or directions can be selected providing a corresponding number of filters 311. Thus, each of filters 311(1)-311(n) may be “assigned” to a corresponding assigned interferer direction by configuring the polar response pattern of the filter to create null in the sensitivity pattern in the corresponding assigned direction. In this manner, the audio space surrounding the microphone sensor array may be divided into segments, and the frequency response of each filter may be specifically tailored to suppress interferer sound signals emitted from a corresponding assigned segment.

The filters 311 may be derived assuming the signal model shown above in (1) and (2). For some embodiments, the filters 311 may be characterized by a transfer function H(s) as shown in (3), where m indexes the null direction:

$${H}_{m} ( s ) = K \frac{s + {ω}_{zm}}{s + {ω}_{pm}} \qquad ( 3 )$$

The gain factor may be expressed as K shown below in (4), where A is a near-field gain parameter:

$$K = \frac{A - 1}{A + 1} \qquad ( 4 )$$

The zero of each filter 311 may be expressed as:

$${ω}_{zm} = \frac{1}{K} \frac{2}{{Δ}_{m}^{′}} \qquad ( 5 )$$

and the pole of each filter may be expressed as:

$${ω}_{pm} = K \frac{2}{{Δ}_{m}^{′}} \qquad ( 6 )$$

The time constant appearing in both the zero and pole equations is
Δ′ₘΔₘ+Δₛ (7)
where the time-delay corresponding to the selectable-null is

$${Δ}_{m} = \frac{- d}{c} cos {θ}_{m} \qquad ( 8 )$$

and compensating for the time-delay corresponding to the speaker direction yields

$${Δ}_{s} = \frac{d}{c} cos {θ}_{s} \qquad ( 9 )$$

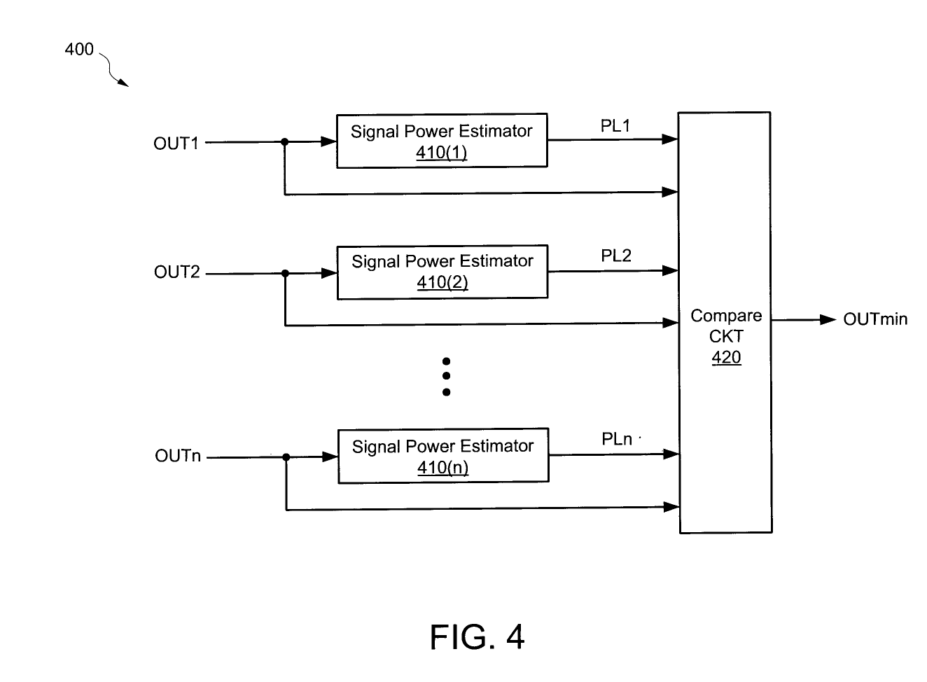

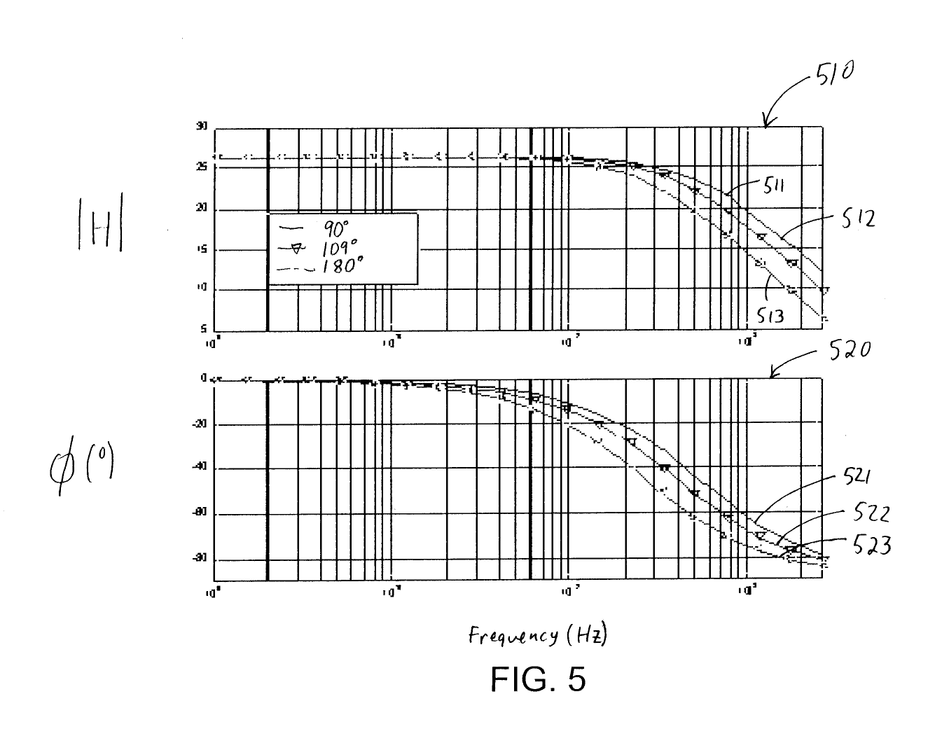

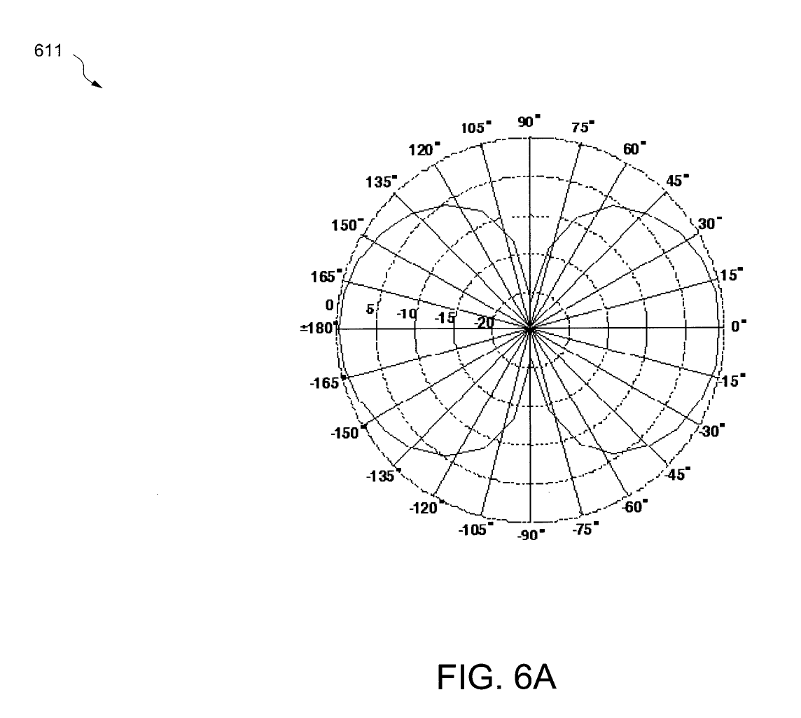

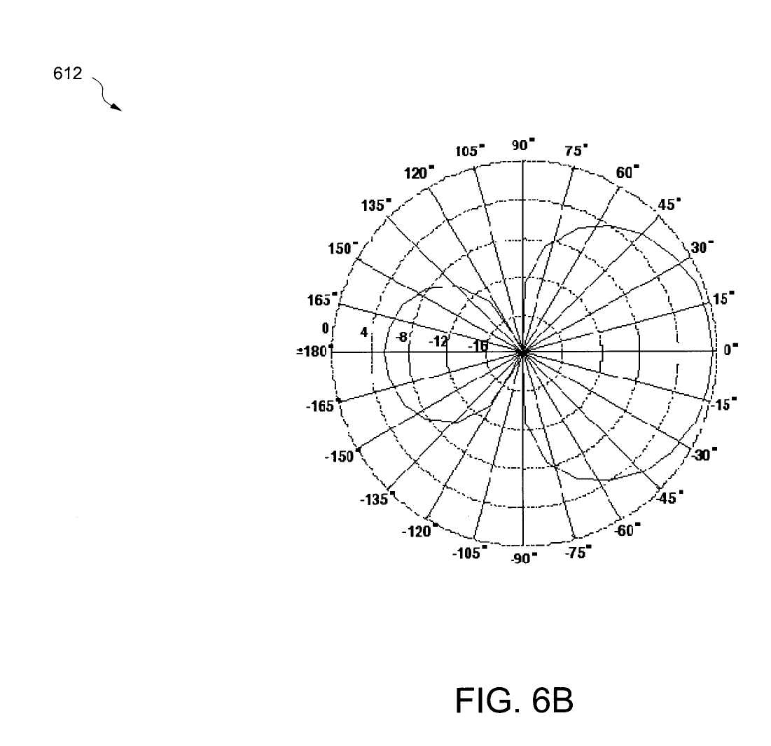

For example, referring again to FIG. 3, for an exemplary embodiment in which null steering circuit 300 includes 3 filtering circuits 310(1)-310(n), each of the 3 corresponding fixed filters 311(1)-311(3) may be configured to have a null in a different specified direction. More specifically, referring to the magnitude response plot 510 and phase response plot 520 of FIG. 5, a first filter 311(1) may be configured as a first-order low pass filter (LPF) having a magnitude response 511 with a corner frequency of 521 Hz and having a phase response 521, a second filter 311(2) may be configured as a first-order LPF having a magnitude response 512 with a corner frequency of 331 Hz and having a phase response 522, and a third filter 311(3) may be configured as a first-order LPF having a magnitude response 513 with a corner frequency of 261 Hz and having a phase response 523. For this example, the frequency response of the first filter 311 (1) results in a broadside null, figure-8 type polar response pattern 611 having nulls at 90° and at −90° relative to the SPKR located at 0°, as shown in FIG. 6A, the frequency response of the second filter 311(2) results in a hyper-cardioid type polar response pattern 612 having nulls at 109° and at −109° relative to the SPKR located at 0°, as shown in FIG. 6B, and the frequency response of the third filter 311(3) results in cardioid type polar response pattern 613 having a null at 180° relative to the SPKR located at 0°, as shown in FIG. 6C.

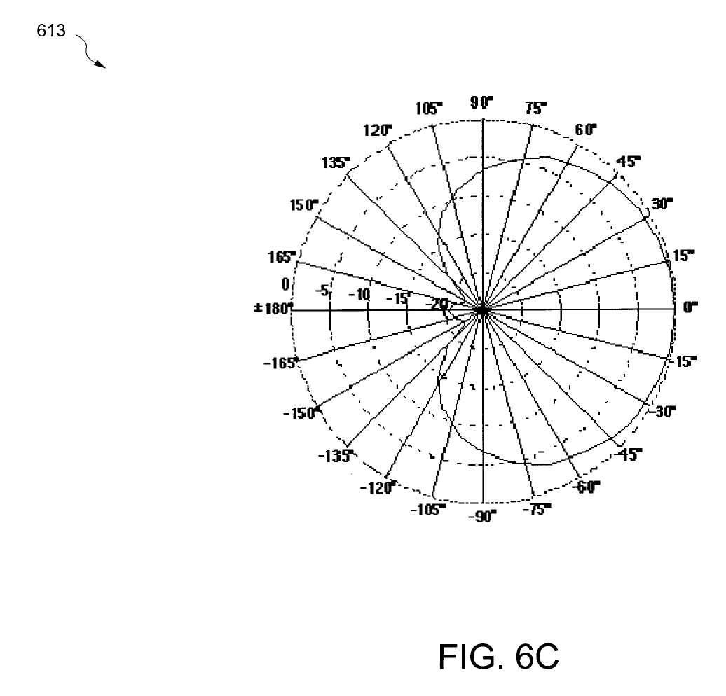

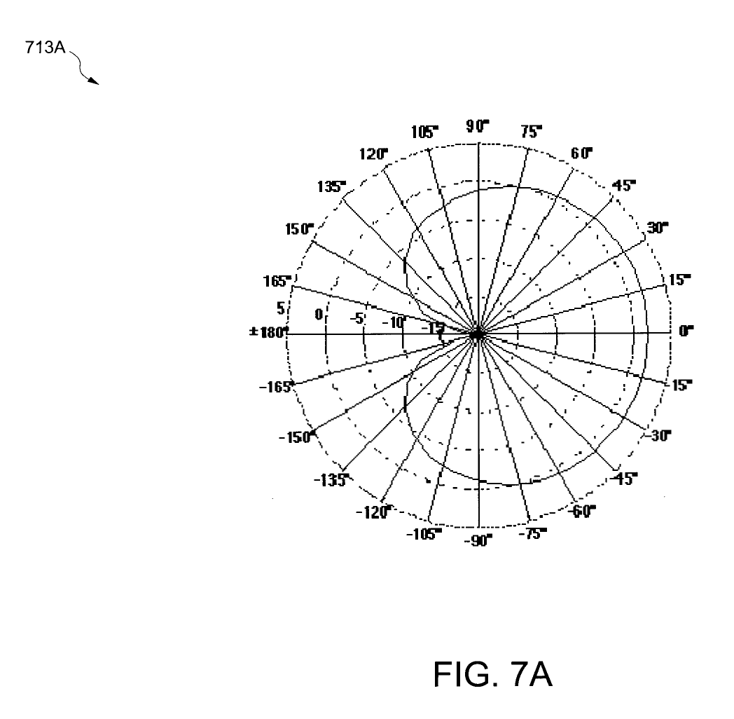

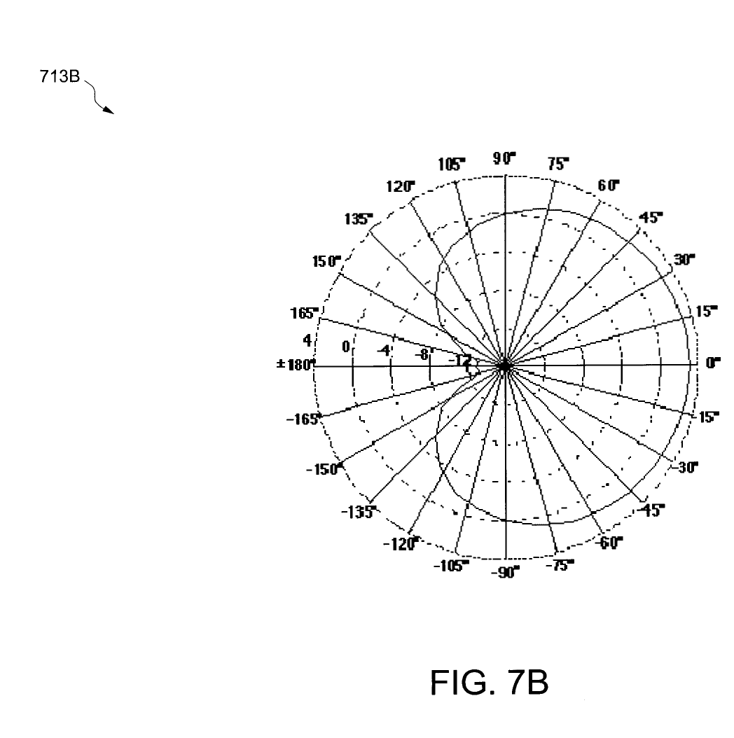

The polar response patterns of FIGS. 6A-6C are composite plots generated using well-known root-mean-square (RMS) value of attenuation referenced to twice the signal level of the M1 input signal (which provides the 0 dB reference) over a frequency from 1 to 4 kHz. Referring to FIG. 6C, note that the null at 180° is actually a minor lobe with symmetrical nulls near the at 180° axis direction. At lower frequencies, the polar response pattern of the third filter 311(3) having the frequency response 513/523 includes a null at 180°, and the null begins to drift away from the at 180° axis as frequency increases. For example, FIGS. 7A-7C show polar response plots 713A-713C for the third filter 311(3) at 200 Hz, 1 kHz, and 4 kHz, respectively.

Referring again to FIG. 3, within each filtering circuit 310, its fixed filter 311 generates a filtered delay signal FDx that is subtracted from the sum signal SUM in the corresponding subtraction circuit 312 to generate a filter output signal OUTx in which INT components from a corresponding direction are suppressed. For example, for the exemplary embodiment in which null steering circuit 300 includes 3 filters 311(1)-311(3) having the polar response patterns shown in FIGS. 6A-6C, the filtered signal I1 generated by first filter 311(1) matches components of INT signals emitted from a direction of 90° relative to the SPKR so that when subtracted from SUM the corresponding filter output signal OUT1 suppresses INT signals from 90° while preserving the SPKR signals. Similarly, the filtered signal I2 generated by second filter 311(2) matches components of INT signals emitted from a direction of 109° relative to the SPKR so that when subtracted from SUM the corresponding signal OUT2 suppresses INT signals from 1090 while preserving the SPKR signals, and the filtered signal I3 generated by first filter 311(1) matches components of INT signals emitted from a direction of 180° relative to the SPKR so that when subtracted from SUM the resulting filter output signal P3 suppresses INT signals from 180° while preserving the SPKR signals. In this manner, each filter 311 can be specifically and accurately tuned to cancel speaker components from a particular direction.

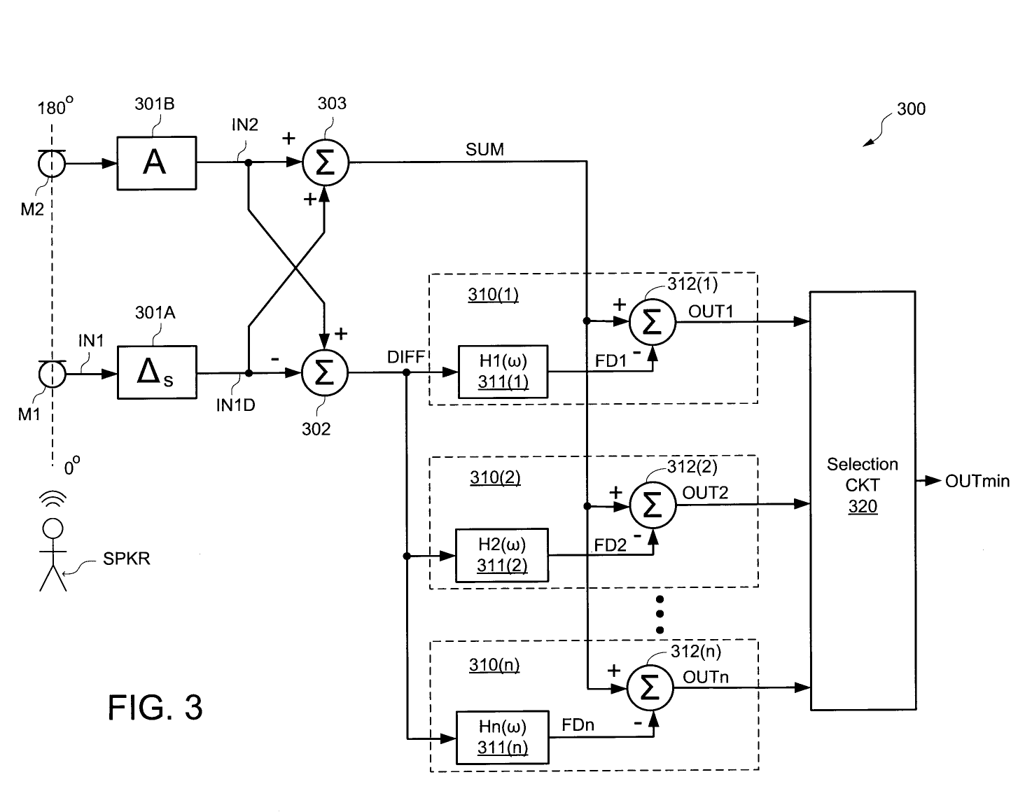

The selection circuit 320 selects one of the filter output signals OUT1-OUTn that provides the best cancellation of the interferer INT while preserving the SPKR sound signals. Any suitable technique and/or circuit may be employed to perform the function of selection circuit 320. For example, FIG. 4 shows a selection circuit 400 that is one embodiment of selection circuit 320 of FIG. 3. Selection circuit 400 includes a plurality of signal power estimator (SPE) circuits 410(1)-410(n) and a compare circuit 420. Each SPE circuit 410 includes an input to receive a corresponding filter output signal OUT from a corresponding filtering circuit 310, and includes an output coupled to a corresponding input of compare circuit 420. Compare circuit 420 also includes inputs to receive the filter output signals OUT1-OUTn. Each SPE circuit 410 estimates the sound energy contained in the corresponding filter output signal OUT, and in response thereto generates a power level signal PL indicative of the signal energy. SPE circuits 410 may use any suitable technique for estimating the power of signal P including, for example, RMS, mean-square, peak detection, envelope detection, and so on.

The compare circuit 420 compares the power level signals PL1-PLn provided by respective SPE circuits 410(1)-410(n) with each other to determine which of the corresponding filter output signals OUT1-OUTn has the least amount of energy, and selects that signal to be output as the minimum-energy output signal OUTₘᵢₙ. Selection circuit 420 may be implemented using any suitable compare and select circuits.

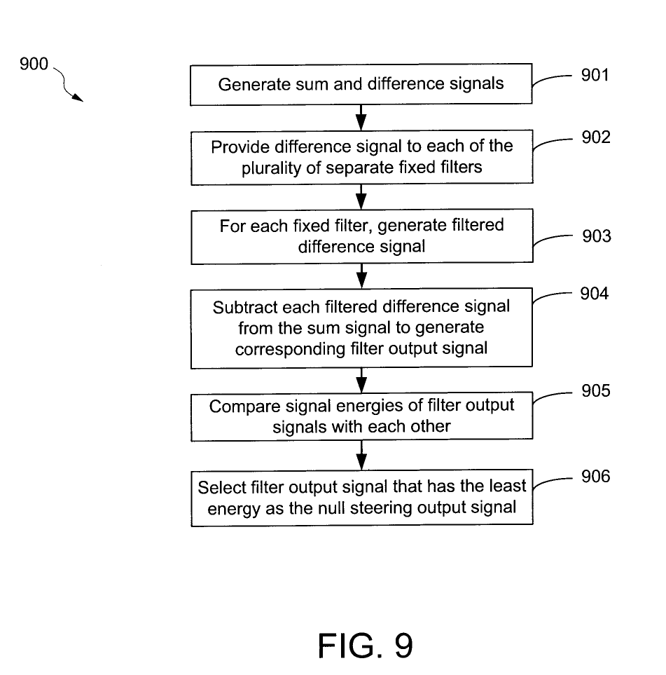

An exemplary operation of one embodiment of null steering circuit 300 is described below with respect to the illustrative flow chart 900 of FIG. 9. First, in response to sound signals emitted by a desired SPRK and unwanted interferer and received by microphone sensors M1-M2, SUM and DIFF signals are generated (step 901). Then, DIFF is provided as an input signal to each of the filtering circuits 310(1)-310(n) containing respective fixed filters 311(1)-311(n) (step 902). Then, each filter 311 generates a filtered difference signal FD (step 903). Each filtered difference signal FD is subtracted from SUM to generate a filter output signal OUT (step 904). Next, the selection circuit compares the filter output signals with each other to determine which signal has the least amount of energy (step 905) and selects the filter output signal having the least amount of energy as the minimum-energy output signal OUTₘᵢₙ.

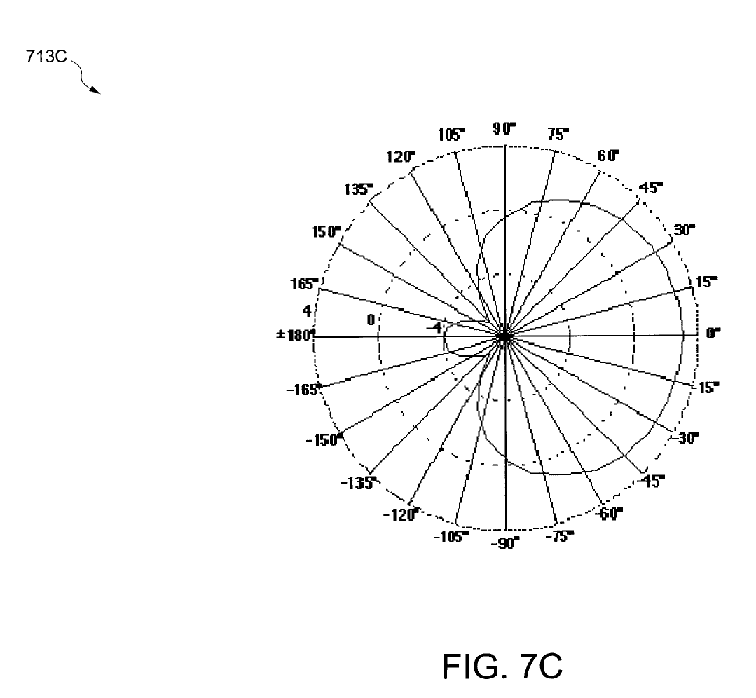

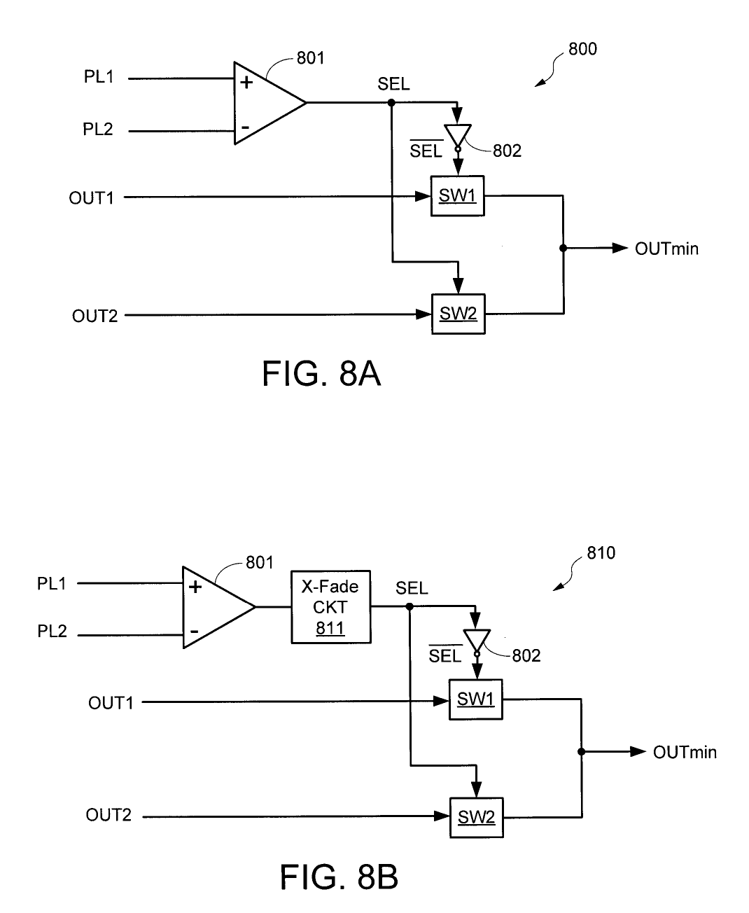

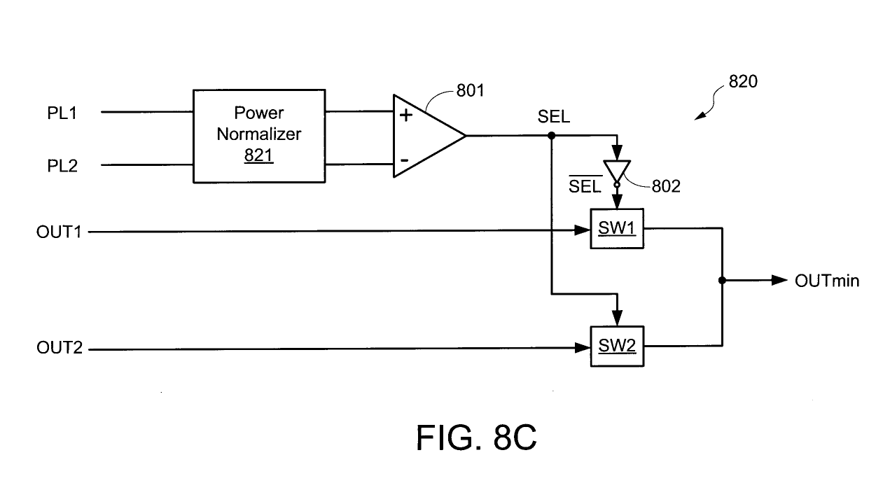

FIG. 8A shows a 2-input selection circuit 800 that is one embodiment of selection circuit 400 of FIG. 4. Selection circuit 800 includes a comparator 801, an inverter 802, and two switches SW1-SW2. Comparator 801 has inputs to receive power level signals PL1-PL2 from SPE circuits 410 of FIG. 4, and an output to generate a select signal SEL. The select signal SEL is provided to a control terminal of SW2, which includes an input to receive OUT2 and an output to generate OUTₘᵢₙ. The select signal SEL is also provided to inverter 802, which logically inverts SEL to generate an inverted select signal S̅E̅L̅ that is provided to a control terminal of SW1, which includes an input to receive OUT2 and an output to generate OUTₘᵢₙ.

Inverter 802 and switches SW1-SW2 are well-known. For some embodiments, inverter 802 is a CMOS inverter, although other signal inversion circuits may be used. For one embodiment, switches SW1 and SW2 are well-known CMOS transmission gates. For another embodiment, switches SW1 and SW2 are NMOS or PMOS pass gates. For other embodiments, other switching circuits may be used.

In operation, if the signal power of OUT1 is less than the signal power of OUT2, comparator 801 drives SEL to a first state that causes SW1 to pass OUT1 as the selected minimum-energy output signal OUTₘᵢₙ and that causes SW2 to not pass OUT2. Conversely, if the signal power of OUT2 is less than the signal power of OUT1, comparator 801 drives SEL to a second state that causes SW2 to pass OUT2 as OUTₘᵢₙ and that causes SW1 to not pass OUT1.

For some embodiments, comparator 801 is implemented as a high-gain op-amp. Further, for some embodiments, the comparator 801 or its op-amp implementation may employ hysteresis to prevent switching between filtering circuits 310 in response to relatively small changes in signal power of OUT1 and OUT2 (e.g., to provide smoother transitions and to avoid spurious switching). For other embodiments, the comparator 801 or its op-amp implementation may employ a time-averaging technique when changing the output signal selection, for example, so that the null steering circuit 300 changes the selection of filters 311 only if the INT changes locations (or direction relative to the SPKR) for more than a predetermined period of time. In this manner, a very brief variation in location of the INT does not cause the null steering circuit 300 to changes its selection of filters 311.

The operation of selection circuit 800 in switching between various filtered signals (e.g., OUT1 and OUT2) may be performed either instantaneously or over a period of time (e.g., either gradually or time-averaged). For some applications, it may be desired to switch the output signal selection between filters 311 in a gradual manner (e.g., as the INT moves from a first location corresponding to the null effected by the first filter 311(1) to a second location corresponding to the null effected by the second filter 311(2)). For such applications, the selection circuit 800 may be modified to more gradually switch between the selection of filter signals OUT1-OUT2. For other embodiments, a cross-fade circuit 811 may be coupled to the output of comparator 801, as shown in FIG. 8B, to decrease the slew rate of SEL. For one embodiment, the cross-fade circuit 811 may be implemented by providing a capacitor C between the output of comparator 801 and ground potential.

For other applications, it may be desired to extend the signal power range over which the selection circuit operates. For example, FIG. 8C shows a 2-input selection circuit 820 that is another embodiment of selection circuit 400 of FIG. 4. Selection circuit 820 includes all the elements of selection circuit 800 of FIG. 8A, with the addition of a signal power normalization circuit 821 coupled to the inputs of comparator 801 and configured to adjust the power levels of the signals PL prior to input to comparator 801. For example, for one embodiment, the signal power normalization circuit may be configured to estimate the total signal power of all filter output signals OUT1-OUTn and then divide each individual filter output signal OUT by the total to create normalized filter output signals for input to comparator 801. In this manner, the filter output signals OUT received by comparator 801 are relative signals rather than absolute signals, and therefore if the signal power of filter output signals OUT is greater than or less than the levels for which comparator 801 is designed for, comparator 801 may still operate properly. Of course, signal power normalization circuit 821 may be coupled to the inputs of comparator 801 of selection circuit 810 of FIG. 8B, and more generally to the outputs of SPE circuits 410 of FIG. 4.

Referring again to FIG. 3, the function of selection circuit 320 may also be performed by well-known loser-take-all circuit that selects the minimum-power signal generated by filtering circuits 310(1)-310(n) to be provided as OUTₘᵢₙ. Alternatively, the signal selection function of selection circuit 320 may be performed using more circuitry that consider other factors. For example, in one embodiment, circuitry may be provided within selection circuit 320 that allows a user can to manually choose an specific operating mode that selects only one filter (e.g., so that the null steering circuit operates using a single fixed polar response pattern).

Preferably, embodiments of the response select null steering circuits described above are implemented using analog circuitry. Analog implementations use much less power than their digital equivalents. More specifically, to be a low power solution, for which embodiments of the present invention are especially suited for, the analog circuitry is preferred over digital circuitry. For example, the primary driver of power consumption in a digital circuit is switching between 0 (logic low) and 1 (logic high), which requires charging and discharging nodal capacitances from ground to the power supply voltage in a short period of time. In contrast, an analog implementation does not require such drastic signal swings in such a short period of time. Further, because a single signal is represented digitally using several bits, several nodes must be simultaneously charged and discharged for each operation, whether a computation or a memory access. In analog, a signal is represented by a voltage on one or at most two nodes if a single-ended or differential scheme is used respectively.

In a digital implementation, the period of time required to charge and discharge each node is driven by the clock frequency and the clock frequency is driven by the number of operations that need to occur between signal samples. The signal sample rate is determined to be at least twice the frequency of the highest frequency content of the signals to be processed, which results in significant power consumption.

Further, an operation that can be implemented almost instantaneously in analog may require more computational steps in a digital solution. Additionally, several analog operations can occur in parallel whereas a typical digital solution would process each step serially. The more serial steps needed within the required sampling rate described above will increase the needed clock frequency and therefore drive up the power of the digital solution. In the analog design, power can be traded for area.

Finally, an analog implementation does not need data converters and the power they would require. The null response-select solution of the present invention is easier to implement in analog, as opposed to implementing a solution using a fully adaptive filter. Moreover, the allowable null-angles are more easily controllable with the response-select architecture of the present invention.

Null-Filter Frequencv Response Derivation

Referring again to FIG. 3, the sum-path signal (SUM) is given by
X_{S}(ω)=A+e^{-jωΔ′}
and the difference-path signal (DIFF) is given by
X_{D}(ω)=A−e^{-jωΔ′}
For the interferer to be cancelled, the following condition has to be met
X_{S}(ω)−H(ω)X_{D}(ω)=0

Given the previous results, the null-filter transfer function required to cancel an interferer from a given direction over the frequency range of operation may therefore be expressed as

$$\begin{matrix}H ( ω ) = \frac{{X}_{S} ( ω )}{{X}_{D} ( ω )} \\ = \frac{A + {ⅇ}^{- j ω {Δ}^{′}}}{A - {ⅇ}^{- j ω {Δ}^{′}}}\end{matrix}$$

Substituting s=jω leads to

$$H ( s ) = \frac{A + {ⅇ}^{- s {Δ}^{′}}}{A - {ⅇ}^{- s {Δ}^{′}}} , \qquad s = j ω$$

It is desirable to implement this frequency response by an analog filter, i.e. a ratio of two polynomials in the variables=jω. This leads to the use of Padé approximants.

Bilinear Transform

The bilinear transform is a special case of a Padé approximant to e^{-SΔ′} where L=1 and M=1. This approximant is given by

$$\begin{matrix}{R}_{[ 1 / 1 ]} = \frac{{P}_{1} ( s )}{{Q}_{1} ( s )} \\ = \frac{2 - s {Δ}^{′}}{2 + s {Δ}^{′}}\end{matrix}$$

The resulting null filter is given by

$$\begin{matrix}H ( s ) = \frac{A {Q}_{1} ( s ) + {P}_{1} ( s )}{A {Q}_{1} ( s ) - {P}_{1} ( s )} \\ = \frac{A ( 2 + s {Δ}^{′} ) + ( 2 - s {Δ}^{′} )}{A ( 2 + s {Δ}^{′} ) - ( 2 - s {Δ}^{′} )} \\ = K \frac{s + {ω}_{z}}{s + {ω}_{p}}\end{matrix}$$

Where

$$K = \frac{( A - 1 )}{( A + 1 )} , {ω}_{z} = \frac{1}{K} \frac{2}{{Δ}^{′}} , and {ω}_{p} = K \frac{2}{{Δ}^{′}}$$

define the gain factor, zero corner frequency, and pole corner frequency.

Thus, the bilinear transform yields a stable filter. Embodiments of the present invention that include a first filter 311(1) providing a null at 0° and a second filter 311(2) providing a null at 900 utilizes this filter approximation.

Although the invention has been described with reference to specific exemplary embodiments thereof, it will be evident that various modifications and changes may be made thereto without departing from the broader spirit and scope of the invention as set forth in the appended claims. The specification and drawings are, accordingly, to be regarded in an illustrative rather than a restrictive sense.

1. (canceled)

2. A response-select null steering circuit for receiving sound containing signal components from a desired speaker and signal components from an unwanted interferer, the circuit comprising:
a first microphone sensor for producing a first input signal in response to the received sound;
a second microphone sensor for producing a second input signal in response to the received sound;
a first subtraction circuit having inputs responsive to the first and second input signals and having an output to generate a difference signal;
a summing circuit having inputs responsive to the first and second input signals and having an output to generate a sum signal;
a plurality of discrete filtering circuits, each having an input to receive the difference signal and having an output to generate a corresponding filter output signal; and
a selection circuit having a plurality of inputs to receive the filter output signals, and having an output to provide one of the filter output signals as a selected output signal.

3. The circuit of claim 2, further comprising a gain element coupled between the first microphone sensor and the summing circuit.

4. The circuit of claim 3, wherein the speaker comprises a near-field sound source, and the gain element is configured to provide a near-field gain factor to preserve signal components of the speaker and to attenuate signal components of the interferer.

5. The circuit of claim 2, wherein each filtering circuit has a different polar response pattern that produces a null in a unique direction.

6. The circuit of claim 5, wherein the null direction of a first of the filtering circuits is at an angle of approximately 90 degrees relative to an axis of the microphone sensors, the null direction of a second of the filtering circuits is located at an angle of approximately 109 degrees relative to the axis, and the null direction of a third of the filtering circuits is located at an angle of approximately 180 degrees relative to the axis.

7. The circuit of claim 2, wherein each filtering circuit comprises:
a fixed filter having an input to receive the difference signal and an output to generate a corresponding filtered difference signal; and
a second subtraction circuit configured to subtract the corresponding filtered difference signal from the sum signal to generate the corresponding filter output signal.

8. The circuit of claim 7, wherein each of the fixed filters has a unique frequency response.

9. The circuit of claim 7, wherein each of the fixed filters is configured to suppress signal components of the interferer in a unique direction.

10. The circuit of claim 7, wherein a first of the fixed filters has a corner frequency of approximately 521 Hz, a second of the fixed filters has a corner frequency of approximately 331 Hz, and a third of the fixed filters has a corner frequency of approximately 261 Hz.

11. The circuit of claim 2, wherein the selected output signal achieves a maximum suppression of the interferer relative to the other filter output signals.

12. The circuit of claim 2, wherein the selection circuit selects the filter output signal that has the least amount of sound energy as the selected output signal.

13. The circuit of claim 12, wherein the selection circuit is configured to compare the sound energies of the filter output signals with each other to determine which filter output signal has the least amount of sound energy.

14. The circuit of claim 2, wherein the selection circuit comprises:
a plurality of signal power estimator circuits, each having an input to receive a corresponding filter output signal and having an output to generate a power level signal indicative of the sound energy contained in the corresponding filter output signal; and
a compare circuit having a plurality of input pairs, each input pair for receiving a corresponding filter output signal and its associated power level signal, and having an output to provide the selected output signal.

15. The circuit of claim 14, wherein the compare circuit compares the power level signals with each other to determine which filter output signal has the least amount of sound energy.

16. The circuit of claim 15, wherein the compare circuit selects the filter output signal that has the least amount of sound energy.

17. The circuit of claim 14, wherein the compare circuit comprises:
a comparator having first and second inputs to receive first and second filter output signals generated by first and second filtering circuits, respectively, and an output to generate a select signal;
a first switch having an input to receive the first filter output signal, an output to provide the selected output signal, and a control terminal responsive to the select signal; and
a second switch having an input to receive the second filter output signal, an output to provide the selected output signal, and a control terminal responsive to the select signal.

18. The circuit of claim 2, wherein each filter output signal suppresses signal components of the interferer in a unique direction.

19. The circuit of claim 2, wherein the sum signal contains signal components of the interferer and the speaker, and the difference signal suppresses signal components of the speaker.

20. The circuit of claim 2, further comprising:
a delay element coupled between the second microphone sensor and the first subtraction circuit, wherein the delay element, the first subtraction circuit, and the microphone sensors form a fixed beamformer that suppresses signal components of the speaker in a designated direction.

21. A method of suppressing sound from an unwanted interferer while preserving sound from a desired speaker, comprising:
generating first and second input signals in response to the interferer and the speaker sounds;
generating a sum signal in response to the first and second input signals;
generating a difference signal in response to the first and second input signals;
generating a plurality of filter output signals in response to the difference signal, wherein each filter output signal is unique; and
selecting one of the filter output signals for output as a selected output signal.

22. The method of claim 21, wherein the selecting comprises:
comparing sound energies of the filter output signals with each other; and
selecting the filter output signal that has the least amount of sound energy.

23. The method of claim 22, wherein the comparing comprises:
estimating the signal power of each filter output signal;
generating a plurality of power level signals in response to the estimating; and
comparing the power level signals with each other to generate a select signal that indicates which filter output signal has the least amount of sound energy.

24. The method of claim 21, wherein the selected filter output signal has the least amount of sound energy relative to the other filter output signals.

25. The method of claim 21, wherein the selected filter output signal achieves a maximum suppression of the interferer relative to the other filter output signals.

26. The method of claim 21, wherein each filter output signal suppresses signal components from the interferer in a unique direction.

27. The method of claim 21, wherein generating the plurality of filter output signals comprises:
providing the difference signal to a plurality of separate filtering circuits; and
within each filtering circuit:
generating a filtered difference signal; and
subtracting the filtered difference signal from the sum signal to generate a corresponding one of the filter output signals.

28. The method of claim 27, wherein each filtering circuit has a different polar response pattern that produces a null in a unique direction.

29. The method of claim 27, wherein each filtering circuit suppresses signal components of the interferer in a different direction.

30. A response-select null steering circuit for receiving sound containing signal components from a desired speaker and signal components from an unwanted interferer, the circuit comprising:
means for generating first and second input signals in response to the interferer and the speaker sounds;
means for generating a sum signal in response to the first and second input signals;
means for generating a difference signal in response to the first and second input signals;
means for generating a plurality of filter output signals in response to the difference signal, wherein the filter output signals are unique; and
means for selecting the filter output signal that has the least amount of sound energy.

31. The circuit of claim 30, wherein the means for selecting comprises:
means for comparing sound energies of the filter output signals with each other to determine which filter output signal has the least amount of sound energy.

32. The circuit of claim 30, wherein the selected filter output signal achieves a maximum suppression of the interferer relative to the other filter output signals.

33. The circuit of claim 30, wherein each filter output signal suppresses signal components from the interferer in a unique direction.

34. The circuit of claim 30, wherein the means for generating the plurality of filter output signals comprises a plurality of discrete filtering circuits connected in parallel.

35. The circuit of claim 34, wherein each filtering circuit has a different polar response pattern that produces a null in a unique direction.

36. The circuit of claim 34, wherein each filtering circuit comprises:
a fixed filter having an input to receive the difference signal and having an output to generate a corresponding filtered difference signal; and
a subtraction circuit configured to subtract the corresponding filtered difference signal from the sum signal to generate the corresponding filter output signal.

37. The circuit of claim 36, wherein each of the fixed filters has a unique frequency response.

38. The circuit of claim 36, wherein each of the fixed filters is configured to suppress signal components of the interferer in a unique direction.

39. The circuit of claim 30, wherein the means for selecting comprises:
a selection circuit configured to compare the sound energies of the filter output signals with each other.

40. The circuit of claim 39, wherein the selection circuit comprises:
a plurality of signal power estimator circuits, each having an input to receive a corresponding filter output signal and having an output to generate a power level signal indicative of the sound energy contained in the corresponding filter output signal; and
a compare circuit having a plurality of input pairs, each input pair for receiving a corresponding filter output signal and its associated power level signal, and having an output to provide the selected output signal.

41. The circuit of claim 40, wherein the compare circuit compares the power level signals with each other.

42. The circuit of claim 40, wherein the compare circuit comprises:
a comparator having first and second inputs to receive first and second filter output signals generated by first and second filtering circuits, respectively, and an output to generate a select signal;
a first switch having an input to receive the first filter output signal, an output to provide the selected output signal, and a control terminal responsive to the select signal; and
a second switch having an input to receive the second filter output signal, an output to provide the selected output signal, and a control terminal responsive to the select signal.
